(19) United States
(12) Patent Application Publication
(10) Pub. No.: US 2005/0169821 A1
(43) Pub. Date: Aug. 4, 2005

(54) Air treatment system for a vehicle

(75) Inventors: Bjorn Boschert, Ditzingen (DE); Marcus Frey, Korb (DE); Christian Grommer, Stetten (DE); Tilo Rinckler, Tamm (DE)

Correspondence Address: FOLEY AND LARDNER;SUITE 500, 3000 K STREET NW, WASHINGTON, DC, 20007, US

(73) Assignee: BEHR GmbH & CO. KG, Stuttgart (DE)

(21) Appl. No.: 10/509,173

(22) PCT Filed: Mar. 25, 2003
(86) PCT No.: PCT/EP03/03100

(30) Foreign Application Priority Data
Mar. 25, 2002 (DE) 102 13 195.3

(51) Int. Cl. B01J 19/08

(52) U.S. Cl. 422/186.07

(57) ABSTRACT

The invention relates to an air treatment system (1) for a vehicle, especially a motor vehicle, which comprises a channel system (2) for guiding a current of air (17), comprising an inlet opening (6) for fresh air that communicates with the surroundings (7) of the vehicle, and a plurality of outlet openings (10) that communicate with the vehicle interior (9). The system further comprises a ventilator (3) for generating the current of air (17) in the channel system (2), a heating device (5) for heating up the current of air (17) and a cooling device (4) for cooling the current of air, and an oxidation device (41) that is electrically operated and decomposes odors and/or pollutants contained in the current of air (17).

The present invention relates to an air treatment system for a vehicle, in particular for a motor vehicle.

Such an air treatment system usually comprises a ducting system, which serves to direct a current of air and which has a fresh air inlet opening that communicates with the surroundings of the vehicle and an inlet opening for recirculated air that communicates with an interior of the vehicle which is to be air-conditioned. The ducting system furthermore generally has a plurality of outlet openings, such as central vents, side vents, footwell vents and windshield vents, that communicate with the vehicle interior. A blower capable of generating a current of air in the ducting system is arranged in this ducting system. In addition, a heating device capable of heating the current of air is arranged in the ducting system. The heating device is usually a heat exchanger through which the cooling circuit of the internal combustion engine of the vehicle flows. In addition, in modern air treatment systems a cooling device for cooling the current of air is arranged in the ducting system. The cooling device usually comprises an evaporator of a refrigeration circuit, which takes the form of a through-flow heat exchanger. Air treatment systems of this type may also be equipped with a particle filter and with an odor and/or pollutant filter. Use is made, for example, of activated charcoal filters which absorb odors and pollutants. With increasing deposits of odorous substances and pollutants such filters gradually become clogged, so that their through-flow resistance increases and their absorption capacity diminishes. Consequently it is necessary to replace such filters regularly.

Moreover, with permanently moist air ducts having inadequate drainage there is generally a risk of micro-organisms such as fungi, algae and bacteria being able to form and multiply on surfaces exposed to the current of air, especially in moist areas, for example on the evaporator. This formation of microorganisms may cause an odor nuisance for persons exposed to the current of air.

The object of the present invention is to specify an improved embodiment for an air treatment system of the aforementioned type, which in particular discloses new possible ways of preventing or reducing microorganisms and odorous substances/pollutants in the current of air.

According to the invention this object is achieved by the subjects of the independent claims. Advantageous embodiments form the subject of the dependent claims.

The invention is based on the general idea of equipping the air treatment system with an oxidation device, which functions electrically and which breaks down (oxidizes) odorous substances and/or pollutants contained in the current of air by means of oxidation. The proposed oxidation device therefore serves to modify the chemical structure of the odorous substances and pollutants carried in the current of air so that the unwanted or harmful effect of these substances can be reduced. In particular, it is possible to thereby reduce the risk of microorganisms forming in the ducting system. Since the oxidation device used according to the invention functions electrically, it is particularly easy to control the activity of this device.

The invention therefore makes it quite possible to dispense with a pollutant/odor filter, since adequate decomposition of the odorous substances and pollutants in the current of air can be achieved by the oxidation. It is equally possible to combine the oxidation device with a pollutant and/or odor filter, allowing the filter to have a structure presenting less flow-resistance, since the consequently reduced filter capacity can be compensated for by the effect of the oxidation.

According to an advantageous embodiment the oxidation device may have at least one ozone generator, which electrically generates ozone in the current of air in order to thereby enrich the current of air with ozone. As is known, ozone is an unstable, gaseous compound of three oxygen atoms and thereby constitutes a strong oxidizing agent. Ozone can therefore be used to oxidize pollutants/odorous substances and microorganisms and in this way to eliminate them or render them harmless.

The sterilizing action of the ozone is effective provided that the ozone-charged current of air impinges on a surface occupied by microorganisms, for example, on the evaporator.

The ozone generator can in principle be designed so that in operation it only generates just enough ozone to ensure that, even if there are no odorous substances or pollutants in the current of air or no microorganisms present on the surfaces exposed to the current of air, the surfaces on which the current of air impinges are sufficiently large to bring about a breakdown of the ozone thereon, which will reduce the ozone content of the current of air to or below a predefined limit before the current of air enters the vehicle interior through the outlet opening(s). This measure ensures that in generating the ozone no ozone concentration hazardous to health develops in the vehicle interior.

A health hazard due to ozone entering the vehicle interior can also be avoided according to a further embodiment in which at least one catalyzer, which breaks down the ozone contained in the current of air, is arranged downstream of the ozone generator. Such a catalyzer at the same time assists the oxidation of the pollutants and odorous substances, thereby enhancing the purifying effect of the ozone.

The catalyzer used in conjunction with the ozone generator suitably takes the form of a sorption catalyzer, which absorbs the pollutants/odorous substances and assists in their oxidation in conjunction with a suitably reactive oxidizing agent such as ozone. Such a sorption catalyzer may contain activated charcoal, for example.

The air treatment system may be operated, by means of a suitable control system, for example, in a purification mode in which the ozone generator is active and enriches the current of air with ozone, the current of air in this purification mode being directed so that the entire current of air reaching the outlet opening(s) first flows through the catalyzer. This design construction ensures that in the purification mode no ozone reaches the vehicle interior.

The air treatment system may furthermore be operated, by means of a suitable control system, for example, in a sterilization mode in which the ozone generator is active and enriches the current of air with ozone, a first baffle device being provided, which is automatically actuated, in particular by the control system, and which in the sterilization mode directs the current of air so that no ozone-charged air enters the vehicle interior through the minimum of one outlet opening. For example, all outlet openings are closed by means of corresponding switch elements. Whereas in the purification mode pollutants and odorous substances are removed from the current of air delivered to the vehicle interior, in the sterilization mode the surfaces in the air treatment system are sterilized in so far as they come into contact with the ozone.

In a particular further embodiment a first ozone generator may be provided, which is arranged upstream of the catalyzer and is active in the purification mode, a second ozone generator also being provided which is arranged downstream of the catalyzer and is active in the sterilization mode. This design construction ensures that in the purification mode when the first ozone generator is in operation the entire current of air is directed through the catalyzer, so that downstream of the catalyzer the current of air no longer contains any ozone. In the sterilization mode the second ozone generator then active ensures that the current of air also contains ozone downstream of the catalyzer, so that sections of the ducting system situated downstream of the catalyzer can also be sterilized.

In an alternative embodiment a common ozone generator may be provided for the purification mode and the sterilization mode, it being possible to deactivate the catalyzer for the sterilization mode. In contrast to the aforementioned embodiment, this variant only requires one ozone generator, thereby saving overall space.

Such an embodiment is particularly easy to achieve, for example, by means of a second baffle device which in the sterilization mode directs the current of air so that this completely or substantially bypasses the catalyzer. In this way two alterative flow paths are formed in the ducting system, the catalyzer being arranged in one flow path whilst the other flow path bypasses the catalyzer. This design construction is also inexpensive to produce.

In an alternative embodiment the catalyzer may be so designed and/or arranged that it can be switched between an active position assigned to the purification mode, in which the catalyzer projects into a flow path of the ozone-enriched current of air and through which the latter flows, and a passive position assigned to the sterilization mode, in which the catalyzer is completely or substantially removed from the flow path and is entirely or substantially bypassed by the ozone-enriched current of air. This embodiment also manages with just a single ozone generator for both operating modes, the adjustable catalyzer taking up comparatively little overall space.

Of particular interest is an embodiment in which in the sterilization mode a switch element of the first baffle device opens an outlet air path, which directs the current of air into the surroundings of the vehicle and/or returns it into the ducting system upstream of the blower, the switch element closing the outlet air path in normal operation of the air treatment system. Since in the sterilization mode no air may enter the vehicle interior through the outlet openings, blind sections or “cul-de-sacs” can form in the ducting system, the size of which depends on where the switch element for closing the outlet opening(s) is arranged. The outlet air path allows a flow through these “cul-de-sacs” as far as the switch element. At best, therefore, the ducting system can be subjected to ozone and sterilized right up to the outlet opening(s).

In an alternative embodiment the oxidation device may have at least one photocatalyzer device, which comprises at least one UV-emitter and at least one catalyzer in the form of a photocatalyzer and which causes UV radiation to act upon at least one photocatalyzer (45) in order to oxidize the odorous substances and/or pollutants. The UV radiation serves to intensify or initiate the oxidation of the pollutants/odorous substances on the photocatalyzer. The UV-assistance means that an adequate oxidation of the unwanted substances can be achieved by means of the photocatalyzer.

Such a photocatalyzer is suitably designed as oxidation catalyzer and may in particular contain TiO₂ and/or Pt.

Of particular interest is an embodiment in which the catalyzer used in conjunction with the respective oxidation device is integrated into an existing component of the air treatment system, this component being exposed to the current of air and/or having the current of air flowing through it. In this embodiment the respective component of the air treatment system assumes an additional function, at the same time saving overall space. For example, the catalyzer may be integrated into a blower for generating the current of air, into a heating device for heating the current of air, into the cooling device for cooling the current of air and/or into at least one wall section of the ducting system.

This integration of the catalyzer into the respective component may be suitably achieved by coating a surface of the respective component exposed to the current of air with a suitable catalytic material. In addition, or alternatively, the integration may also be effected in such a way that the respective component is manufactured, at least in an area exposed to the current of air, from a suitable catalytic material. In these embodiments the actual design of the respective component does not have to be modified in order to integrate the catalyzer into it, with the result that these measures can be inexpensively implemented even in existing design constructions.

Further important features and advantages of the invention are set forth in the dependent claims, in the drawings and in the associated description of the figures referring to the drawings.

It goes without saying that the aforementioned features and those still to be explained below may be used not only in the particular combination specified but also in other combinations or individually without departing from the scope of the present invention.

Preferred examples of embodiments of the invention are shown in the drawings and will be explained in more detail in the following description, in which the same reference numerals are used to refer to identical components or ones performing an identical or similar function.

In the Schematic Drawings:

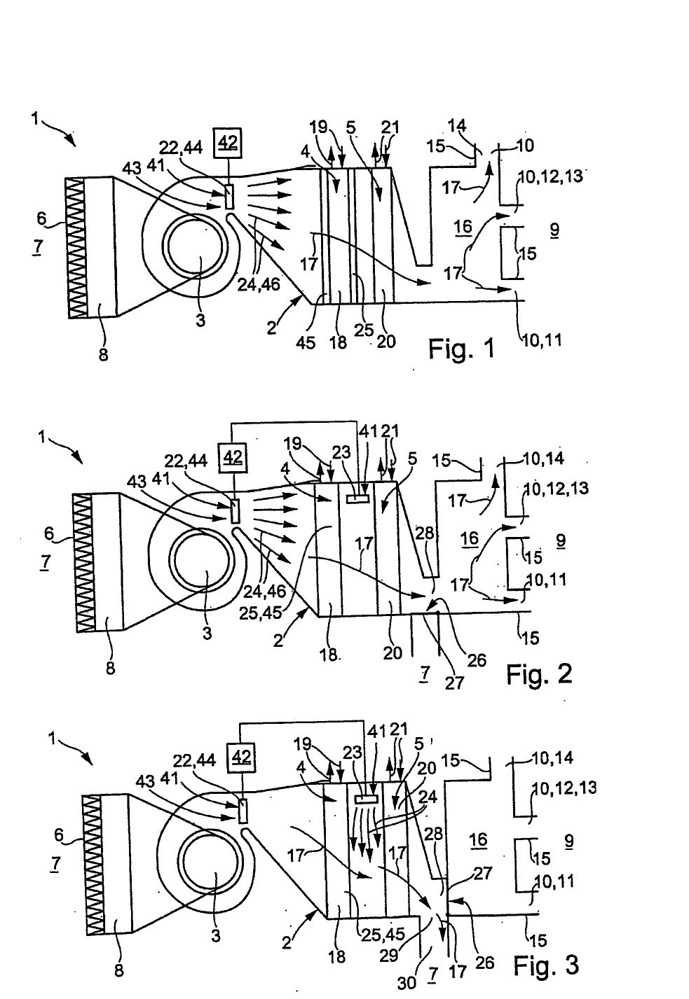

FIG. 1 shows a simplified schematic representation of an air treatment system according to the invention in a first embodiment,

FIG. 2 shows a view as in FIG. 1, but in a second embodiment in a purification mode,

FIG. 3 shows a view as in FIG. 2, but in a purification mode,

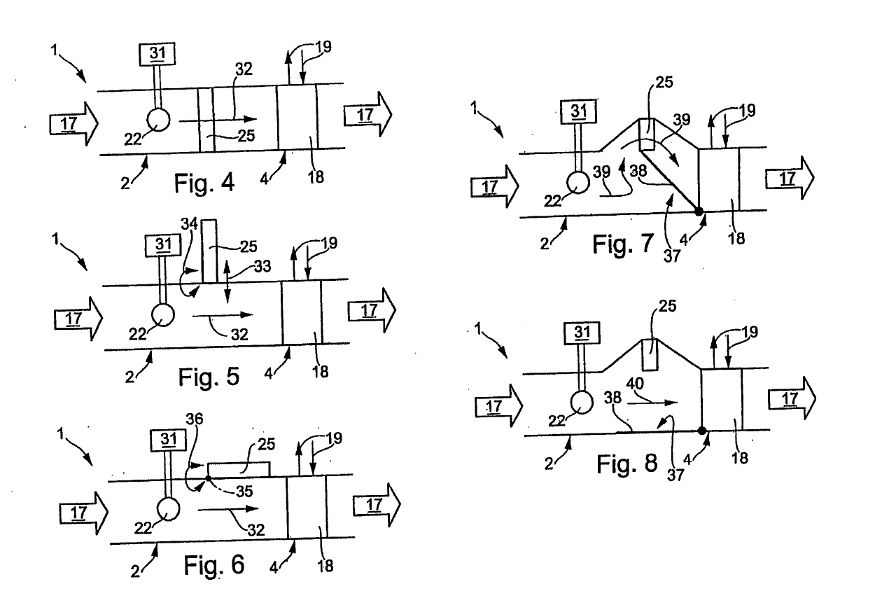

FIG. 4 shows another greatly simplified representation of an air treatment system according to the invention in a third embodiment with activated catalyzer,

FIG. 5 shows a view as in FIG. 4, but with deactivated catalyzer,

FIG. 6 shows a view as in FIG. 5, but in a fourth embodiment,

FIG. 7 shows a view as in FIG. 4, but in a fifth embodiment with activated catalyzer,

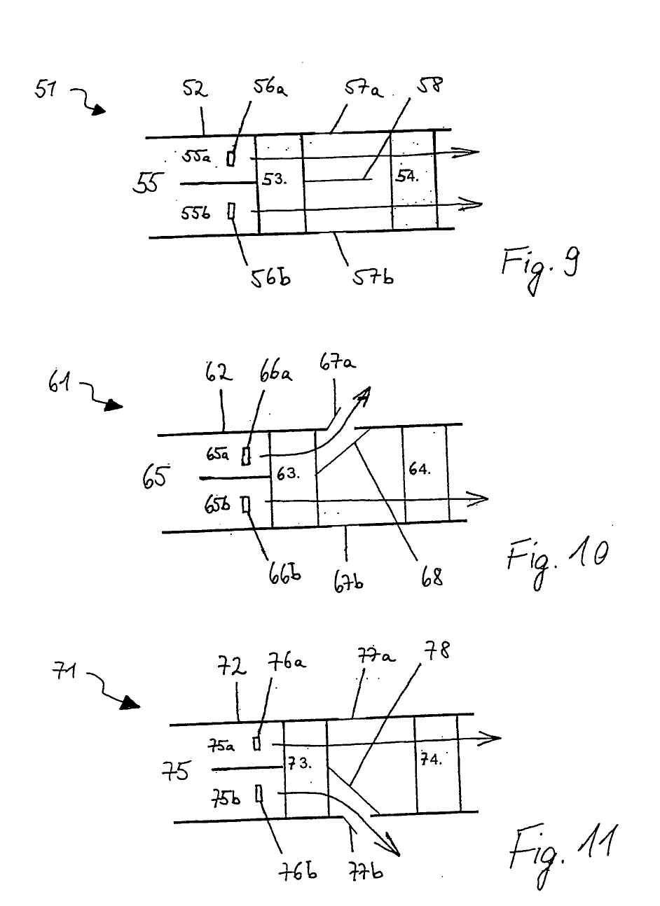

FIG. 8 shows a view as in FIG. 7, but with deactivated catalyzer,

FIG. 9 shows another greatly simplified representation of an air treatment system according to the invention,

FIG. 10 shows a greatly simplified representation of an air treatment system in a sterilization mode, and

FIG. 11 shows a greatly simplified representation of an air treatment system in a further sterilization mode.

According to FIG. 1 to 3 an air treatment system 1 according to the invention for a vehicle (not shown), in particular for a motor vehicle, comprises a ducting system 2, in which a blower 3, a cooling device 4 and a heating device 5 are arranged. The ducting system 2 moreover has an inlet opening 6 through which fresh air from the surroundings 7 of the vehicle can enter the ducting system 2. A particle filter or a so-called “hybrid filter” 8 (that is one in which a conventional particle filter and an activated charcoal filter are combined into one unit) is arranged in the area of the inlet opening 6. In addition to the fresh air inlet opening 6 shown here, the ducting system 2 usually has a further inlet opening for re-circulated air at a point not shown here. This inlet opening communicates with an interior 9 of the vehicle which is to be air-conditioned by means of the air treatment system 1.

For air conditioning of the interior 9 the ducting system 2 has a plurality of outlet openings 10 which each communicate with the vehicle interior 9. For example, the outlet opening 10 shown at the bottom may take the form of a footwell vent 11, whilst the outlet opening 10 shown in the middle forms a central vent 12 or a side vent 13. The outlet opening 10 shown at the top may be a windshield vent or defroster vent 14. In the here greatly simplified representation, duct sections 15, with which the outlet openings 10 communicate via a distributor chamber 16, are shown as being relatively short, but it will be apparent that these duct sections 15 may be appreciably longer where they lead to the side vents 13, for example.

The blower 3 serves to generate a current of air 17, which in the drawings is symbolized by arrows. The cooling device 4 essentially comprises an evaporator 18, which is conventionally connected to a refrigeration circuit 19, which in the drawings is symbolized by arrows. The evaporator 18 is conventionally designed as a through-flow heat exchanger. The current of air 17 flowing through the evaporator 18 may be cooled to a greater or lesser degree depending on the temperature of the evaporator.

The heating device 5 correspondingly comprises a heating element 20, which takes the form of a through-flow heat exchanger and is connected to a corresponding heating circuit 21. In the drawings this heating circuit 21 is again symbolized by arrows and may be connected, for example to a cooling circuit of an internal combustion engine of the vehicle. The current of air 17 may be heated to a greater or lesser degree as it flows through the heating element 20, depending on the temperature of the heating element 20.

According to the invention the air treatment system 1 is equipped with an oxidation device 41, which is connected to a power supply 42. The oxidation device 41 functions electrically as described in more detail below and in operation oxidizes odorous substances and pollutants which may be entrained in the current of air 17, thereby breaking these substances down.

According to a first variant this oxidation device 41 may have at least one ozone generator 22 or 23. Such an ozone generator 22, 23 may function by means of a dielectrically impeded discharge or corona discharge. In operation such an ozone generator 22, 23 generates ozone, which in FIG. 1 to 3 is symbolized by arrows 24, and can consequently increase the ozone content of the current of air 17. Ozone is a highly effective oxidizing agent and is capable of breaking down odorous substances and/or pollutants and microorganisms in the current of air 17. Similarly, ozone is capable of eliminating or reducing microorganisms that have formed on surfaces of the ducting system 2, provided that the ozone comes into contact therewith.

In the embodiment according to FIG. 1 there is only a single ozone generator 22. A catalyzer 25 is arranged in the ducting system 2 downstream of this ozone generator 22. Such a catalyzer 25 can take the form, for example, of a sorption catalyzer and may serve to break down the ozone contained in the current of air 17. At the same time the effect of the ozone on the pollutants or odorous substances in the catalyzer 25 can be enhanced. In the embodiment shown in FIG. 1 the catalyzer 25 is already arranged downstream of the evaporator 18, for reasons of space, for example, so that the catalyzer 25 together with the evaporator 18 may form one structural unit.

Taking into account the sterilizing effect of the ozone it is advisable, where possible, to arrange the catalyzer 25 downstream in the ducting system 2 but immediately upstream of the outlet openings 10 so as to be able to sterilize as much of the ducting system 2 as possible. The same considerations make it advisable to arrange the ozone generator 22 as far forwards as possible in the ducting system 2. In the embodiment shown here the ozone generator 22 is in any case situated upstream of the evaporator 18. This arrangement ensures that it is precisely the moist area which surrounds the evaporator 18 and is particularly susceptible to the formation of microorganisms that is protected against such formation of microorganisms.

In a second variant the oxidation device 41 may have at least one photocatalyzer device 43, which has a UV emitter 44 and a catalyzer 45 in the form of a photocatalyzer. For the sake of simplicity, the UV emitter 44 and the first ozone generator 22 in FIG. 1 to 3 are in each case represented by the same element. Similarly, in FIGS. 2 and 3 the catalyzer 25 on the outlet side of the first ozone generator 22 and the photocatalyzer 45 needed for the photocatalysis are represented by the same element. Accordingly, in the embodiment according to FIG. 1 the photocatalyzer 45 is connected to the inlet side of the evaporator 18, it also being possible here for the photocatalyzer 45 together with the evaporator 18 to form one structural unit. The UV emitter 44 is connected to the power supply 42 and in operation generates a UV radiation, which in FIGS. 1 and 2 is represented by arrows 46. The UV radiation 46 therefore acts upon the photocatalyzer 45, which takes the form, for example, of an oxidation catalyzer with titanium oxide and/or platinum. This UV irradiation increases the reactivity on the photocatalyzer 45, so that the odorous substances/pollutants incident upon the photocatalyzer 45 are oxidized thereon.

In the embodiment in FIGS. 2 and 3 the catalyzer 25 assigned to the first ozone generator 22 or the photocatalyzer 45 assigned to the UV emitter 44 is integrated into the evaporator 18. This integration is achieved, for example, by coating at least part of the surface of the evaporator 18 on which the current of air impinges with a suitable catalytically active material. This can be done, for example, by means of a powder coating or by painting. It is equally possible to manufacture at least part of the evaporator 18 from a suitable catalytic material in order to produce catalytically active surfaces.

It is also quite possible to modify some other component of the air treatment system 2 so that this contains the catalyzer 25 or the photocatalyzer 45 as an integral component. For example, the catalyzer 25 of the photocatalyzer 45 could also be integrated into the heating element 20. It is equally quite possible to integrate the catalyzer 25 or the photocatalyzer 45 into the blower 3, for example, the first ozone generator 22 or the UV emitter 44 then having to be arranged upstream of the blower 3. In addition the catalyzer 25 or the photocatalyzer 45 could also be integrated into wall sections of the ducting system 2 on which the current of air 17 impinges. It is also possible to integrate the catalyzer 25 or the photocatalyzer 45 at least partially into a rectifier and/or into a droplet collector of the cooling device 4.

In the embodiment represented in FIG. 1 the air treatment system 1 can be operated either permanently or as required with a purification mode in which the first ozone generator 22 generates ozone or in which the UV emitter 44 irradiates the photocatalyzer 45 in order to break down pollutants and odorous substances contained in the current of air 17. At the same time, at least in the variant with the ozone generator 22, the surfaces of the air treatment system 1 on which the current of air 17 impinges can be sterilized as far as the evaporator 25.

In the embodiment in FIGS. 2 and 3 the air treatment system 1 has two ozone generators 22 and 23 and can thereby be operated in a purification mode represented in FIG. 2 and in a sterilization mode represented in FIG. 3. In the purification mode according to FIG. 2 the first ozone generator 22 arranged upstream of the catalyzer 25 generates ozone for treatment of the current of air 17.

Downstream of the catalyzer 25, that is to say after the evaporator 18, the current of air 17 then no longer contains any ozone. The current of air 17 is fed to the distributor chamber 16 in the usual manner and is then distributed to the individual outlet openings 10. In the purification mode the second ozone generator 23 is switched off.

For operation in the sterilization mode shown in FIG. 3 the air treatment system 1 contains a first baffle device 26, which in the embodiment shown here is essentially formed by a flap-shaped switch element 27. This switch element 27 controls an inlet opening 28 of the distributor chamber 16 on the one hand, and on the other an inlet opening 29 of an outlet air path 30, which branches off upstream of the distributor chamber 16. Whereas in the purification mode the switch element 27 closes the outlet air path 30 and opens the inlet opening 28 of the distributor chamber 16, in the sterilization mode the switch element 27 is set so that it closes the distributor chamber 16 and opens the inlet opening 29 of the outlet air path 30. Correspondingly, in the sterilization mode the current of air 17 is led off through the outlet air path 30. The outlet air path 30 may lead into the surroundings 7 of the vehicle, for example. It is equally possible to return the outlet air path 30 closed into the ducting system 2 upstream of the blower 3. Such an outlet air path 30 may be formed, for example, by an existing condensate drain.

According to FIG. 3, in the sterilization mode the second ozone generator 23 arranged downstream of the catalyzer 25 is active, so that this generates ozone downstream of the catalyzer 25 as shown by the arrows 24 and introduces it into the current of air 17. In this way it is possible to also sterilize areas downstream of the catalyzer 25. The sterilizing current of air 17 is here fed through the heating element 20 to the distributor chamber 16. Although in the representation according to FIG. 3 the first ozone generator 22 is deactivated in the sterilization mode, it may also be appropriate to also actively operate the first ozone generator 22 in the sterilization mode.

It is equally possible to design the baffle device 26 so that in the sterilization mode the sterilizing current 17 reaches the duct section 15 or even as far as the outlet openings 10. For example, such a switch element 27 is then assigned to each outlet opening 10. The outlet air path 30 is then arranged at a suitable point, it being likewise possible to provide multiple outlet air paths 30.

Isolating the outlet openings 10 from the current of air 17 in this way ensures that in the sterilization mode no ozone can get into the vehicle interior 9. It is advisable for the first baffle device 26 to be actuated or controlled automatically. For example, in order to avoid reduced levels of comfort, the air treatment system 1 can operate in a sterilization mode, as necessary, when there is no air conditioning requirement for the vehicle interior 9, in particular when the user has switched off the actual air treatment system 1.

Although in the embodiments shown in FIG. 1 to 3 the two variants of the oxidation device 41, that is to say at least one ozone generator 22, 23 on the one hand and at least one photocatalyzer device 43 on the other, are designed as alternatives, it is quite possible for the oxidation device 41 to have both variants operating cumulatively.

As in FIGS. 2 and 3, FIG. 4 to 8 also show embodiments in which the air treatment system 1 can be operated both in the purification mode and in the sterilization mode. In contrast to the embodiment in FIGS. 2 and 3, however, the embodiments shown in FIG. 4 to 8 manage with a single ozone generator 22.

In FIG. 4 to 8 the air treatment system 1 is again shown greatly simplified. The ozone generator 22 is arranged in the ducting system 2 downstream of the blower 3 (not shown) and is connected to a control and/or power supply 31, which may be arranged externally, that is outside the ducting system 2. The catalyzer 25 is here designed as separate component and is arranged in the ducting system 2 upstream of the cooling device 4 or upstream of the evaporator 18, for example. The current of air 17 is again symbolized by arrows. It will be clear that in principle some other position within the ducting element 2 may be selected for arrangement of the catalyzer 25, for example downstream of the heating element 20, the positioning possibly depending on the space available.

In the embodiments in FIG. 4 to 6 the catalyzer 25 is arranged or designed to be adjustable between an active position according to FIG. 4 and a passive position according to FIGS. 5 and 6. In its active position according to FIG. 4 the catalyzer 25 projects into a flow path for the ozone-enriched current of air 17 formed in the ducting system 2 and symbolized by an arrow 32, so that that this current of air 17 is bound to flow through the catalyzer 25. The active position of the catalyzer 25 is accordingly assigned to the purification mode, which is performed with outlet openings 10 open.

According to FIGS. 5 and 6 the catalyzer 25 in its passive position is displaced out of the flow path 32, so that the current of air bypasses or substantially bypasses the catalyzer. Accordingly the passive position may be used to achieve the sterilization mode, since an ozone-charged current of air 17 can now also impinge on surfaces downstream of the catalyzer 25. This can be used, for example, to sterilize the surface of the evaporator 18 exposed to the current of air 17.

In the embodiment according to FIG. 5 the catalyzer 25 is capable of translational adjustment transversely to the flow path 32 between its active position and its passive position as indicated by a double arrow 33. It is equally possible to arrange the catalyzer 25 so that it can be pivoted between passive position and active position about a swivel axis running parallel to the flow path 32 as indicated by a rotational double arrow 34.

According to FIG. 6 the catalyzer 25 is arranged so that it can be pivoted between active position and passive position about an axis of rotation 35 running perpendicular to the flow path 32 as indicated by the rotational double arrow 36.

Whereas in the embodiments in FIG. 4 to 6 the catalyzer 25 is adjustable between an active position and a passive position, FIGS. 7 and 8 show an embodiment with fixed catalyzer 25. In the embodiment in FIGS. 7 and 8 a second baffle device 37 is provided, which here essentially has a flap-shaped switch element 38. The switch element 38 controls two flow paths inside the ducting system 2 in the area of the catalyzer 25. In FIG. 7 the switch element 38 is swiveled so that a first flow path 39 is formed, which directs the current of air 17 through the catalyzer 25. In this switch position the catalyzer 25 is therefore activated, so that this switch position is assigned to the purification mode.

In contrast to this, in FIG. 8 the switch element 38 is swiveled so that a second flow path 40 is formed which bypasses the catalyzer 25. The current of air 17 on the second flow path 40 accordingly bypasses the catalyzer 25. Ozone-charged air can therefore get into areas of the ducting system 2 situated downstream of the catalyzer 25. Although the catalyzer 25 according to FIG. 8 is in principle exposed to the current of air 17, the latter essentially does not flow through the catalyzer since the catalyzer 25 has too great a flow resistance for this; diffusion processes are in this case negligible. The catalyzer 25 is therefore activated in the switch position shown in FIG. 8, so that this switch position of the switch element 38 is assigned to the sterilization mode.

The embodiments shown in FIG. 4 to 8 are of particular interest, since these manage with a single ozone generator 22 and still allow the air treatment system 1 both a purification mode and a sterilization mode.

For the purification mode it is important that the entire current of air 17 ultimately passing through the outlet openings 10 into the vehicle interior 9 should first (inevitably) flow through the catalyzer 25, in order to ensure that an excessive ozone content cannot be produced in the vehicle interior 9.

For the sterilization mode it is essential that no ozone should get into the vehicle interior 9 during flushing of the ducting system 2. The baffle device 28 in the sterilization mode therefore ensures that the outlet openings 10 are separated from the ozone-charged current of air 17.

A further example of embodiment of an air treatment system 51, 61 and 71 according to the invention is shown in greatly simplified form in FIGS. 9, 10 and 11 respectively. A cooling device 53, 63 and 73 and a heating device 54, 64 and 74 are situated in a ducting system 52, 62 and 72 respectively. In this embodiment air flowing through an air duct 55, 65 and 75 is directed in parallel through an upper air duct 55a, 65a and 75a and a lower air duct 55b, 65b and 75b respectively, which are separated by a dividing wall.

In normal operation without sterilization (FIG. 9) the air from the two air ducts 55a and 55b is recombined in the area of the heating device 54 and directed into the passenger compartment, for example. Ozone generators 56a, and 56b situated in the air ducts 55a and 55b respectively do not generate any ozone in normal operation. Flaps 57a and 57b in this case close off openings to outlet air paths (not shown) and a switch element 58 is in a neutral position, so that the air can flow equally through the two ducts 55a and 55b.

In a first sterilization mode (FIG. 10) an ozone generator 66a operates so that the current of air in the upper air duct 65a is enriched with ozone. The upper area of the cooling device on which the ozone-enriched air impinges is sterilized by the oxidizing effect of the ozone. The air, still possibly containing ozone, is then discharged into the surroundings by a switch element 68 through an outlet air path (not shown), the opening of which in this mode is exposed by a flap 67a.

In the first sterilization mode an ozone generator 66b is switched off, so that after having been cooled by the cooling device 63 in its lower area and heated by the heating device 64 the air flowing through the lower air duct 65b can be directed into a passenger compartment, for example. This means that the passenger compartment can be air conditioned or heated whilst sterilizing at least a part of the cooling device.

A second sterilization mode (FIG. 11) is based on the same principle as the first sterilization mode illustrated in FIG. 10. In order to sterilize a lower area of the cooling device 73, an ozone generator 76b in the lower air duct 75b is operated. The ozone thereby generated serves for sterilization of the lower area of the cooling device 73 and is then directed by means of a switch element 78 through an opening exposed by a flap 77b into an outlet air path (not shown) and thence into the surroundings.

By operating an air treatment system according to the invention in the first and second sterilization mode alternately a cooling device can be successively sterilized without having to temporarily or permanently dispense with air conditioning, in particular of a passenger compartment.

List of Reference Numerals

1 Air treatment system
2 Ducting system
3 Blower
4 Cooling device
5 Heating device
6 Inlet opening
7 Surroundings
8 Filter
9 Vehicle interior
10 Outlet opening
11 Footwell vent
12 Central vent
13 Side vent
14 Windshield vent
15 Duct section
16 Distributor chamber
17 Current of air
18 Evaporator
19 Refrigeration circuit
20 Heating element
21 Heating circuit
22 Ozone generator
23 Ozone generator
24 Generated ozone
25 Catalyzer
26 Baffle device
27 Switch element
28 Inlet opening of 16
29 Inlet opening of 30
30 Outlet air path
31 Control and/or power supply of 22
32 Flow path
33 Translational movement of 25
34 Rotational movement of 25
35 Swivel axis of 25
36 Rotational movement of 25
37 Baffle device
38 Switch element
39 First flow path
40 Second flow path
41 Oxidation device
42 Power supply
43 Photocatalyzer device
44 UV emitter
45 Photocatalyzer
46 UV radiation
51 Air treatment system
52 Ducting system
53 Cooling device
54 Heating device
55 Air duct
56 Ozone generator
57 Flap
58 Switch element
61 Air treatment system
62 Ducting system
63 Cooling device
64 Heating device
65 Air duct
66 Ozone generator
67 Flap
68 Switch element
71 Air treatment system
72 Ducting system
73 Cooling device
74 Heating device
75 Air duct
76 Ozone generator
77 Flap
78 Switch element

1. An air treatment system for a vehicle, in particular a motor vehicle,
having a ducting system (2) for directing a current of air (17), which has at least one fresh air inlet opening (6) that communicates with the surroundings (7) of the vehicle and/or at least one inlet opening for recirculated air that communicates with an interior (9) of the vehicle which is to be air-conditioned, and at least one outlet opening (10) that communicates with the vehicle interior (9),
having an oxidation device (41) which functions electrically and breaks down odorous substances and/or pollutants contained in the current of air (17) by oxidation.

2. The air treatment system as claimed in claim 1, characterized in that the oxidation device (41) has at least one ozone generator (22,23) for generating ozone in the current of air (17).

3. The air treatment system as claimed in claim 2, characterized in that the ozone generator (22,23) is designed so that in operation it only generates just enough ozone to ensure that, even if there are no odorous substances or pollutants in the current of air (17) or no microorganisms present on the surfaces exposed to the current of air (17), the surfaces on which the current of air (17) impinges are sufficiently large to bring about a breakdown of the ozone thereon which will reduce the ozone content of the current of air (17) to or below a predefined limit before the current of air (17) enters the vehicle interior (9) through the outlet openings (10).

4. The air treatment system as claimed in claim 2, characterized in that at least one catalyzer (25), which breaks down the ozone contained in the current of air (17), is arranged downstream of the ozone generator (22,23).

5. The air treatment system as claimed in claim 4, characterized in that the catalyzer (25) takes the form of a sorption catalyzer.

6. The air treatment system as claimed in claim 4, characterized in that the air treatment system (1) may be operated in a purification mode in which the ozone generator (22) is active and enriches the current of air (17) with ozone, the current of air (17) in the purification mode being directed so that the entire current of air (17) reaching the outlet opening(s) (10) first flows through the catalyzer (25).

7. The air treatment system as claimed in claim 2, characterized in that the air treatment system (1) may be operated in a sterilization mode in which the ozone generator (22,23) is active and enriches the current of air (17) with ozone, a first baffle device (26) being provided, which in the sterilization mode directs the current of air (17) so that no ozone-charged air enters the vehicle interior (9) through the minimum of one outlet opening (10).

8. The air treatment system as claimed in claim 6, characterized in that a first ozone generator (22) is provided, which is arranged upstream of the catalyzer (25) and is active in the purification mode, and in that a second ozone generator (23) is also provided which is arranged downstream of the catalyzer (25) and is active in the sterilization mode.

9. The air treatment system as claimed in claim 6, characterized in that a common ozone generator (22) is provided for the purification mode and the sterilization mode, it being possible to deactivate the catalyzer (25) for the sterilization mode.

10. The air treatment system as claimed in claim 9, characterized in that a second baffle device (37) is provided, which in the sterilization mode directs the current of air (17) so that this completely or substantially bypasses the catalyzer (25).

11. The air treatment system as claimed in claim 9, characterized in that the catalyzer (25) can be switched between an active position assigned to the purification mode, in which the catalyzer (25) projects into a flow path (32) of the ozone-enriched current of air (17) and through which the latter flows, and a passive position assigned to the sterilization mode, in which the catalyzer (25) is completely or substantially removed from the flow path (32) and is entirely or substantially bypassed by the ozone-enriched current of air (17).

12. The air treatment system as claimed in claim 7, characterized in that the first baffle device (26) has a switch element (27), which is arranged upstream of a distributor chamber (16), from which the conditioned current of air (17) is directed to at least one outlet opening (10), and which in the sterilization mode shuts off the air supply to the distributor chamber (16).

13. The air treatment system as claimed in claim 7, characterized in that the first baffle device (26) has a separate switch element (27) for each outlet opening (10), which in the sterilization mode shuts off the air supply to the respective outlet opening (10).

14. The air treatment system as claimed in claim 12, characterized in that in the sterilization mode the switch element (27) opens an outlet air path (30), which directs the current of air (17) into the surroundings (7) of the vehicle and/or returns it into the ducting system (2) upstream of the blower (3), the switch element (27) closing the outlet air path (30) in normal operation of the air treatment system (1).

15. The air treatment system as claimed in claim 1, characterized in that the oxidation device (41) has at least one photocatalyzer device (43), which comprises at least one UV-emitter (44) and at least one catalyzer (45) in the form of a photocatalyzer and which causes UV radiation to act upon at least one photocatalyzer (45) in order to oxidize the odorous substances and/or pollutants.

16. The air treatment system as claimed in claim 15, characterized in that the photocatalyzer (45) takes the form of an oxidation catalyzer.

17. The air treatment system as claimed in claim 4, characterized in that the catalyzer (25) is integrated into an existing component (2,3,4,5) of the air treatment system, this component being exposed to the current of air (17) and/or having the current of air (17) flowing through it.

18. The air treatment system as claimed in claim 17, characterized in that the catalyzer (25) is integrated into a blower (3) for generating the current of air (17), and/or into a heating device (5) for heating the current of air (17), and/or into the cooling device (4) for cooling the current of air (17) and/or into at least one wall section of the ducting system (2).

19. The air treatment system as claimed in claim 17, characterized in that the integration of the catalyzer (25) into the respective component (2,3,4,5) is achieved
in that a surface of the respective component (2,3,4,5) exposed to the current of air (17) is coated with a suitable catalytic material and/or
in that the respective component (2,3,4,5), at least in an area exposed to the current of air (17), is composed of a suitable catalytic material.

20. The air treatment system as claimed in claim 4, characterized in that the catalyzer (25) is arranged upstream of a distributor chamber (16), from whence the conditioned current of air (17) is directed to at least one outlet opening (10).

21. Use of an electrically functioning oxidation device (41) in an air treatment system (1) of a vehicle, in particular a motor vehicle, for breaking down odorous substances and pollutants by means of oxidation in a current of air (17), which is directed from the air treatment system (1) into an interior (9) of the vehicle.

22. Use of an electrically functioning oxidation device (41) in an air treatment system (1) of a vehicle, in particular a motor vehicle, for sterilizing components (2,3,4,5) of the air treatment system (1) which are exposed to a current of air (17), which in normal operation is directed from the air treatment system (1) into an interior (9) of the vehicle.

23. The use as claimed in claim 21, characterized in that the oxidation device (41) has at least one ozone generator (22,23) for generating ozone in the current of air (17).

24. The use as claimed in claim 21, characterized in that the oxidation device (41) has at least one photocatalyzer device (43), which comprises at least one UV emitter (44) and at least one catalyzer (45) in the form of a photocatalyzer and which causes UV radiation to act upon the at least one photocatalyzer (45) in order to oxidize the odorous substances and/or pollutants
